(19) United States
(12) Patent Application Publication
(10) Pub. No.: US 2026/0158912 A1
(43) Pub. Date: Jun. 11, 2026

(54) SYSTEM FOR NEW VEHICLE OPERATOR

(71) Applicant: Ford Global Technologies, LLC, Dearborn, MI (US)

(72) Inventors: Adam Merz, New Boston, MI (US); Zahra Naila Marks, Detroit, MI (US); Terrence Lavonne Vinson, Louisville, KY (US); LeDarious Jones, Livonia, MI (US); Kelli Beckley, Canton, MI (US)

(73) Assignee: Ford Global Technologies, LLC, Dearborn, MI (US)

(21) Appl. No.: 18/971,002

(22) Filed: Dec. 6, 2024

(51) Int. Cl. B60K 35/28; B60K 35/65; B60W 40/08; B60W 50/14

(52) U.S. Cl. CPC B60K 35/28; B60K 35/65; B60W 40/08; B60W 50/14; B60K 2360/592; B60K 2360/731; B60K 2360/741; B60W 2040/0809; B60W 2050/146; B60W 2540/043; B60W 2556/45

(57) ABSTRACT

A computer includes a processor and a memory, and the memory stores instructions executable by the processor to classify an operator of a vehicle as a new operator of the vehicle based on use of at least one nondriving feature of the vehicle by the operator and, in response to the operator being a new operator of the vehicle, actuate a user interface of the vehicle to convey an instruction to the operator about using a different feature of the vehicle than the at least one nondriving feature.

### BACKGROUND

Modern vehicles include a large number of features. Features are activatable functionalities or sets of functionalities of the vehicle. For example, the features may include advanced driver assistance systems (ADAS). ADAS are electronic technologies that assist drivers in driving and parking functions. Examples of ADAS include forward proximity detection, lane-departure detection, blind-spot detection, braking actuation, adaptive cruise control, and lane-keeping assistance systems. For other examples, features may relate to occupant ergonomics and comfort, climate control, an infotainment interface, etc.

### BRIEF DESCRIPTION OF THE DRAWINGS

FIG. 1 is a block diagram of an example vehicle.

FIG. 2 is a flowchart of an example process for actuating a user interface of the vehicle to instruct an operator of the vehicle based on classifying the operator as a new operator of the vehicle.

### DETAILED DESCRIPTION

The large number of features on modern vehicles can present a new operator of a vehicle with a steep learning curve. A person may be a new operator of a specific vehicle because the vehicle itself is new or because the vehicle has been sold on the secondary market. Because vehicles are bought and sold on the secondary market, the age or total distance driven by the vehicle does not necessarily indicate whether the operator is new to the vehicle or experienced at driving the vehicle.

This disclosure provides techniques for detecting new operators of vehicles in order to assist those operators with the learning curve, while refraining from interposing this assistance to experienced operators of the vehicles. A computer is programmed to classify an operator of a vehicle as a new operator of the vehicle based on use of at least one nondriving feature of the vehicle by the operator and, in response to the operator being a new operator of the vehicle, actuate a user interface of the vehicle to convey an instruction to the operator about using a different feature of the vehicle than the at least one nondriving feature. Certain nondriving features can indicate a change in the regular operator of the vehicle, such as stored seat position, choice of language, newly stored method of unlocking the vehicle, etc. If an operator is new, as indicated by the use of these nondriving features, then the operator could benefit from instructions about other features of the vehicle that the operator may be less familiar with. The computer thus actuates the user interface on the basis of these nondriving features.

A computer includes a processor and a memory, and the memory stores instructions executable by the processor to classify an operator of a vehicle as a new operator of the vehicle based on use of at least one nondriving feature of the vehicle by the operator and, in response to the operator being a new operator of the vehicle, actuate a user interface of the vehicle to convey an instruction to the operator about using a different feature of the vehicle than the at least one nondriving feature.

In an example, the at least one nondriving feature may include at least one of storing a new seat position of a seat of the vehicle, changing a language used by the user interface, disabling a rear seat occupancy alert, storing a new device as a digital key, or storing a new entry code for unlocking the vehicle.

In an example, the instructions may further include instructions to classify the operator as a new operator of the vehicle based on a summation of the uses of the at least one nondriving feature. In a further example, the at least one nondriving feature may include a plurality of nondriving features, and the summation may be a weighted sum of the respective uses of the respective nondriving features.

In another further example, the instructions may further include instructions to classify the operator as a new operator of the vehicle in response to the summation exceeding a threshold.

In another further example, the instructions further include instructions to identify the operator, and the summation is limited to the uses of the at least one nondriving feature by the identified operator.

In an example, the instructions may further include instructions to transmit data indicating usage of the different feature by the operator to a server remote from the vehicle, the usage of the different feature being after the operator received the instruction. In a further example, the instructions may further include instructions to transmit the data to the server on a periodic basis.

In an example, the instructions may further include instructions to, in response to a condition being satisfied, reclassify the operator from a new operator of the vehicle to an experienced operator of the vehicle; and in response to the operator being an experienced operator, refrain from actuating the user interface to convey the instruction about using the different feature of the vehicle.

In an example, the at least one nondriving feature may include storing a new seat position of a seat of the vehicle.

In an example, the at least one nondriving feature may include changing a language used by the user interface.

In an example, the at least one nondriving feature may include disabling a rear seat occupancy alert.

In an example, the at least one nondriving feature may include storing a new device as a digital key.

In an example, the at least one nondriving feature may include storing a new entry code for unlocking the vehicle.

A method includes classifying an operator of a vehicle as a new operator of the vehicle based on use of at least one nondriving feature of the vehicle by the operator and, in response to the operator being a new operator of the vehicle, actuating a user interface of the vehicle to convey an instruction to the operator about using a different feature of the vehicle than the at least one nondriving feature.

In an example, the at least one nondriving feature may include at least one of storing a new seat position of a seat of the vehicle, changing a language used by the user interface, disabling a rear seat occupancy alert, storing a new device as a digital key, or storing a new entry code for unlocking the vehicle.

In an example, the method may further include classifying the operator as a new operator of the vehicle based on a summation of the uses of the at least one nondriving feature. In a further example, the at least one nondriving feature may include a plurality of nondriving features, and the summation is a weighted sum of the respective uses of the respective nondriving features.

In another further example, the method may further include classifying the operator as a new operator of the vehicle in response to the summation exceeding a threshold.

In another further example, the method may further include identifying the operator, and the summation may be limited to the uses of the at least one nondriving feature by the identified operator.

With reference to the Figures, wherein like numerals indicate like parts throughout the several views, a computer 105 includes a processor and a memory, and the memory stores instructions executable by the processor to classify an operator of a vehicle 100 as a new operator of the vehicle 100 based on use of at least one nondriving feature of the vehicle 100 by the operator and, in response to the operator being a new operator of the vehicle 100, actuate a user interface 110 of the vehicle 100 to convey an instruction to the operator about using a different feature of the vehicle 100 than the at least one nondriving feature.

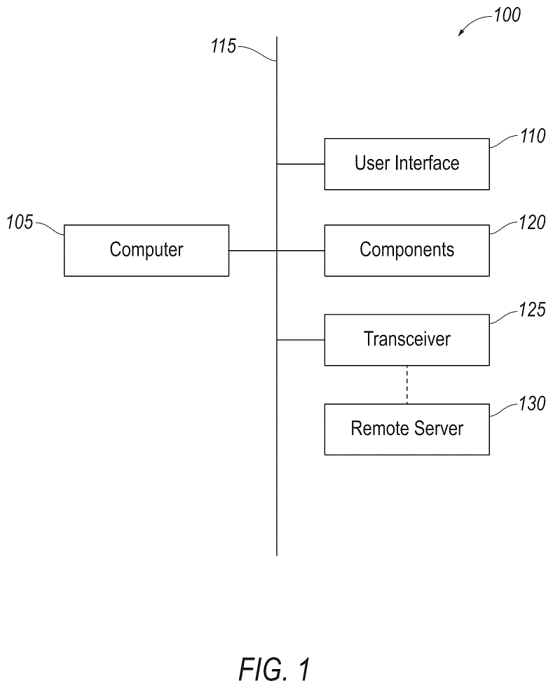

With reference to FIG. 1, the vehicle 100 may be any passenger or commercial automobile such as a car, a truck, a sport utility vehicle, a crossover, a van, a minivan, a taxi, a bus, etc. The vehicle 100 may include the computer 105, a communications network 115, the user interface 110, a plurality of components 120, and a transceiver 125.

The computer 105 is a microprocessor-based computing device such as a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). The computer 105 can thus include a processor, a memory, etc. The memory of the computer 105 can include media for storing instructions executable by the processor as well as for electronically storing data and/or databases, and/or the computer 105 can include structures such as the foregoing by which programming is provided. The computer 105 can be multiple computers coupled together.

The computer 105 may transmit and receive data through the communications network 115. The communications network 115 may be a controller area network (CAN) bus, Ethernet, WiFi, Local Interconnect Network (LIN), onboard diagnostics connector (OBD-II), and/or any other wired or wireless communications network. The computer 105 may be communicatively coupled to the user interface 110, the components 120, and the transceiver 125 via the communications network 115.

The user interface 110 presents information to and receives information from an operator of the vehicle 100. The user interface 110 may be located on an instrument panel in a passenger compartment of the vehicle 100, and/or wherever may be readily seen by the operator. The user interface 110 may include dials, digital readouts, screens, speakers, and so on for providing information to the operator, such as human-machine interface (HMI) elements such as are known. The user interface 110 may include buttons, knobs, keypads, microphone, and so on for receiving information from the operator.

The transceiver 125 may be adapted to transmit signals wirelessly through any suitable wireless communication protocol, such as cellular, Bluetooth®, Bluetooth® Low Energy (BLE), ultra-wideband (UWB), WiFi, IEEE 802.11a/b/g/p, cellular-V2X (CV2X), Dedicated Short-Range Communications (DSRC), other RF (radio frequency) communications, etc. The transceiver 125 may be adapted to communicate with a remote server 130, that is, a server distinct and spaced from the vehicle 100. The remote server 130 may be located outside the vehicle 100. For example, the remote server 130 may be associated with another vehicle (e.g., V2V communications), an infrastructure component (e.g., V2I communications), a first responder, a mobile device associated with the operator of the vehicle 100, a manufacturer or fleet operator of the vehicle 100, etc. The transceiver 125 may be one device or may include a separate transmitter and receiver.

The vehicle 100 has a plurality of features. For the purposes of this disclosure, a “feature” is defined as an activatable functionality or set of functionalities of the vehicle 100. For example, the features may be advanced driver assistance systems (ADAS). ADAS are electronic technologies that assist drivers in driving and parking functions. Examples of ADAS include forward proximity detection, lane-departure detection, blind-spot detection, braking actuation, adaptive cruise control, and lane-keeping assistance systems. The features may also relate to occupant ergonomics and comfort, climate control, an infotainment interface, etc.

The components 120 are actuatable parts of the vehicle 100 that perform the features. For example, the components 120 may include a steering system, which is used to perform the lane-keeping assistance. For another example, the components 120 may include blowers, an air conditioner, a heater, etc. for performing climate control of a passenger compartment of the vehicle 100.

The features may be driving features or nondriving features. A driving feature is a feature that affects or is affected by motion of the vehicle 100 (i.e., driving). Driving features may include ADAS features; control of the propulsion system, steering system, etc.; suspension and handling modes; etc. A nondriving feature is a feature that does not affect and is unaffected by motion of the vehicle 100. Nondriving features may include seat position, climate control, infotainment settings, etc. As described below, the computer 105 relies on use of certain nondriving features to indicate that the operator is a new operator of the vehicle 100.

The computer 105 may be programmed to identify the operator of the vehicle 100. For example, the operator can use a keyfob or the like to start the vehicle 100, and the keyfob can have an RFID tag or the like uniquely specifying the operator from among other potential operators who regularly use the vehicle 100. The RFID signal can be associated with the operator in memory. For another example, a mobile phone or device of the occupant can pair with, for example, the user interface 110 or transceiver 125 of the vehicle 100. The mobile phone or device can be associated with the operator in memory. For another example, the computer 105 can use image data from a camera having a field of view in a passenger compartment of the vehicle 100 including a face of the operator and can identify the occupant using image-recognition techniques as are known. For another example, the operator can enter identifying information such as a username and password into the user interface 110.

The computer 105 may store a classification indicating an experience level of the operator at operating the vehicle 100. The experience level indicates how much experience the operator has at operating the specific vehicle 100, rather than experience at operating vehicles generally. For example, each operator may have a profile stored in the memory of the computer 105, and the classification may be included in the profile. The classification of experience level may be “new” or “experienced,” or an equivalent indication such as 0 for experienced and 1 for new. The classification may thus be stored as a binary variable. The classification may also take on a value indicating “unknown.” Alternatively, a single value (e.g., 0) may indicate that the experience level is one of experienced or unknown. For example, a binary variable may take a value of 0 for experienced or unknown and a value of 1 for new.

The computer 105 is programmed to classify the operator of the vehicle 100 as a new operator of the vehicle 100 based on use of at least one nondriving feature of the vehicle 100 by the operator. The computer 105 may classify the operator as a new operator of the vehicle 100 by setting the variable in the profile to indicate that the operator is a new operator of the vehicle 100 (e.g., by setting the variable to 1).

As a general overview, classifying the operator is based on the use of certain nondriving features by the operator. For example, the computer 105 may store a first list of prespecified nondriving features. The first list includes at least one prespecified nondriving feature (e.g., a plurality of prespecified nondriving features). The computer 105 may classify the operator as a new operator of the vehicle 100 in response to activation of at least one of the prespecified nondriving features. Alternatively or additionally, the computer 105 may store a second list of prespecified nondriving features. The second list includes a plurality of prespecified nondriving features. The second list may be the same as, different than, or partially overlap the first list. The computer 105 may track uses of the prespecified nondriving features on the second list by the operator over time. The computer 105 may determine a score based on the tracked uses by the operator. The computer 105 may classify the operator as a new operator of the vehicle 100 in response to the score exceeding a threshold.

The nondriving features on the first list may be chosen to be settings that are likely to be changed by a new operator of the vehicle 100 and unlikely to be changed by an experienced operator of the vehicle 100. Examples include storing a new seat position of a seat of the vehicle 100, changing a language used by the user interface 110, disabling a rear seat occupancy alert, storing a new device as a digital key, or storing a new entry code for unlocking the vehicle 100 (explained in turn below). The selections for these uses may be stored in the memory of the computer 105, and the selections may persist across key cycles. In other words, when the vehicle 100 is turned off, the selections remain the same the next time that the vehicle 100 is turned on.

Seat position can include multiple degrees of freedom, such as longitudinal position of the seat, height of the seat, tilt of the seat bottom, tilt of the seat back, position of a lumbar support relative to the rest of the seat back, etc. An occupant sitting in the seat can provide inputs (e.g., via buttons on the seat) to adjust the degrees of freedom of the seat. Storing a seat position refers to saving the seat position in the memory of the computer 105, such that the computer 105 is able to command the seat to move into the stored seat position at a later time.

The user interface 110 may provide a variety of text content to the operator on one or more display screens of the user interface 110, such as menus and controls for features of the vehicle 100, settings of the vehicle 100, information about media being played, etc. The user interface 110 may allow the operator to select a language in which the text content is displayed (e.g., English, Spanish, etc.). The selection of the language may dictate how menus, commands, settings, and other prestored information for display by the user interface 110 is displayed.

A rear seat occupancy alert (RSOA) outputs a notification when the vehicle 100 is turned off or the driver door is opened, the notification indicating that something may be in the rear seat. The computer 105 may set the RSOA in response to a rear door being opened after or within a time threshold before the vehicle 100 is started, or in response to a weight sensor reporting weight over a threshold or another occupancy sensor indicating occupancy of the rear seat. Once the RSOA is set, the computer 105 outputs the notification in response to the vehicle 100 being turned off or the driver door being opened. An operator of the vehicle 100 may choose to disable the RSOA so that the notification is no longer outputted.

The vehicle 100 may be unlocked or started with a digital key. A digital key, sometimes implemented with a smartphone or the like as what may be called phone-as-a-key, relies on communication between a mobile device such as a smartphone and the vehicle 100 (e.g., the transceiver 125). When an app is activated on the mobile device and the mobile device is held at a particular location relative to the vehicle 100, such as next to the door handle, the vehicle 100 unlocks the doors. A digital key may communicate with the vehicle 100 using Bluetooth®, Near Field Communication, and/or Ultra-Wideband (UWB).

The vehicle 100 may include an external input device such as a keypad or the like for entering an entry code for unlocking the vehicle 100. Using the entry code to unlock the vehicle 100 may be an alternative to using a keyfob or digital key. With appropriate permissions, the operator may set the entry code (i.e., store a new entry code to the memory of the computer 105, which may replace a previous entry code), and the new entry code can later be used to unlock the vehicle 100.

The nondriving features on the second list may be settings that are changed more frequently by a new operator of the vehicle 100 than by an experienced operator of the vehicle 100. If the summation of nondriving features on the second list (described below) is used instead of the single activation of a nondriving feature on the first list (as described above), then the nondriving features described above for the first list may be included in the second list. In that case, the second list may also include additional nondriving features. If both the summation and the single occurrence are used, then the second list may contain only nondriving features not on the first list. Examples of nondriving features for the second list include creating a Wi-Fi hotspot, storing a radio station or media input as a preset in the memory of the computer 105, etc.

The computer 105 may be programmed to classify the operator as a new operator of the vehicle 100 based on a summation of the uses of the at least one nondriving feature. The computer 105 may track the uses of the nondriving features on the second list and calculate the summation from the tracked uses. The summation may be a weighted sum of the respective uses of the respective nondriving features. For example, each nondriving feature on the second list may have a respective weight, and each term in the summation may be the product of the number of uses of the respective nondriving feature and the respective weight, as in the following expression:

$${S}_{i} = {\sum }_{j = 1}^{n} {w}_{j} {e}_{i , j}$$

in which i is an index of the operators, Sᵢ is the result of the summation for the ith operator, j is an index of the nondriving features on the second list, n is the total number of nondriving features on the second list, wⱼ is the weight of the jth nondriving feature, and e_{i,j} is the number of uses of the jth nondriving feature by the ith operator. The weights may be chosen based on the probative value of the respective nondriving features for indicating that an operator is a new operator of a specific vehicle, and the weights may be prestored in the memory of the computer 105. The summation may be limited to the uses of the nondriving features by the identified operator, as indicated by the subscript i for the summation result Sᵢ and the number of uses e_{i,j}. The computer 105 may classify the operator as a new operator of the vehicle 100 in response to the summation exceeding a threshold (i.e., Sᵢ>S_{threshold}). The threshold may be chosen to be sufficiently low to indicate new operators of the vehicle 100 and sufficiently high to not generate spurious results when an operator is experienced.

The computer 105 is programmed to, in response to the operator being a new operator of the vehicle 100, actuate the user interface 110 to convey an instruction to the operator about using a different feature of the vehicle 100 than the at least one nondriving feature. For example, the user interface 110 may display a pop-up notification on a display screen offering information on the feature if the operator selects an input. The notification may have options for “Show Me More” and “Dismiss” or the like. If the operator selects to receive information on the feature, the computer 105 may actuate the user interface 110 to display a description of what the feature does, steps and/or diagrams explaining how to use the feature, a video showing the operation of the feature, etc.

The feature in the instruction is a different feature than the nondriving features used to classify the operator as a new operator of the vehicle 100. In other words, the feature in the instruction is not on the first list and/or not on the second list. The nondriving features above are chosen for their probative value in identifying new operators of the vehicle 100, and the feature in the instruction may be chosen as a feature that new operators are most likely to benefit from additional instruction about. The feature in the instruction may be a driving feature or a nondriving feature.

The computer 105 may wait until a prespecified event occurs after classifying the operator as a new operator of the vehicle 100 to actuate the user interface 110 to convey the instruction. The prespecified event may be chosen such that the operator is available to read the instruction. For example, the prespecified event may be the vehicle 100 stopping, the vehicle 100 shifting into park, the vehicle 100 starting, etc. In other words, in response to the operator being a new operator, the computer 105 determines to actuate the user interface 110 to convey the instruction upon the next prespecified event that occurs.

The computer 105 may be programmed to collect data indicating usage of the feature in the instruction after the operator received the instruction. The data may include, for example, frequency of usage, duration of usage, settings or inputs during usage, etc. For example, the computer 105 may collect the data over a preset length of time or distance driven, starting when the operator received the instruction. The preset length of time may run only when the vehicle 100 is on. The preset length of time or distance driven may be chosen to be sufficiently long to be representative of the usage of the feature.

The computer 105 may be programmed to transmit the data indicating the usage of the feature in the instruction by the operator to the remote server 130. The remote server 130 may be associated with a manufacturer or fleet operator of the vehicle 100. The computer 105 may transmit the data to the remote server 130 on a periodic basis. For example, the computer 105 may transmit the data at the expiration of a preset period of time, and then begin the next preset period of time. The conditions for transmitting may include the expiration of the preset period of time and the transceiver 125 having a connection for the transmission (e.g., being within range of a Wi-Fi network).

The computer 105 may be programmed to reset the classification of the operator and/or the tracked uses of the nondriving features in response to a condition being satisfied. The condition may be chosen to indicate a sufficient change in the experience level of the operator. For example, the condition may a preset length of time elapsing since classifying the operator as a new operator of the vehicle 100. The preset length of time may be chosen to be sufficiently long for the operator to learn about the features of the vehicle 100 (e.g., one month). For another example, the condition may be a preset number of dismissals of the instructions about the features. The preset number may be chosen to indicate a lack of interest in the instructions (e.g., four).

The computer 105 may be programmed to, in response to the condition being satisfied, reclassify the operator from a new operator of the vehicle 100 to an experienced operator of the vehicle 100. For example, the computer 105 may change the binary variable for the classification in the profile of the operator from 1 to 0, as described above.

The computer 105 may be programmed to, in response to the condition being satisfied, reset the tracked uses for the summation. For example, the computer 105 may set the numbers of uses e_{i,j} to zero for the nondriving features on the second list (i.e., for all values of j).

The computer 105 may be programmed to, in response to the operator being an experienced operator (or the operator having an unknown experience level), refrain from actuating the user interface 110 to convey the instruction about using the different feature of the vehicle 100. In other words, the computer 105 actuates the user interface 110 to convey the instruction only to new operators of the vehicle 100 and not to experienced operators of the vehicle 100.

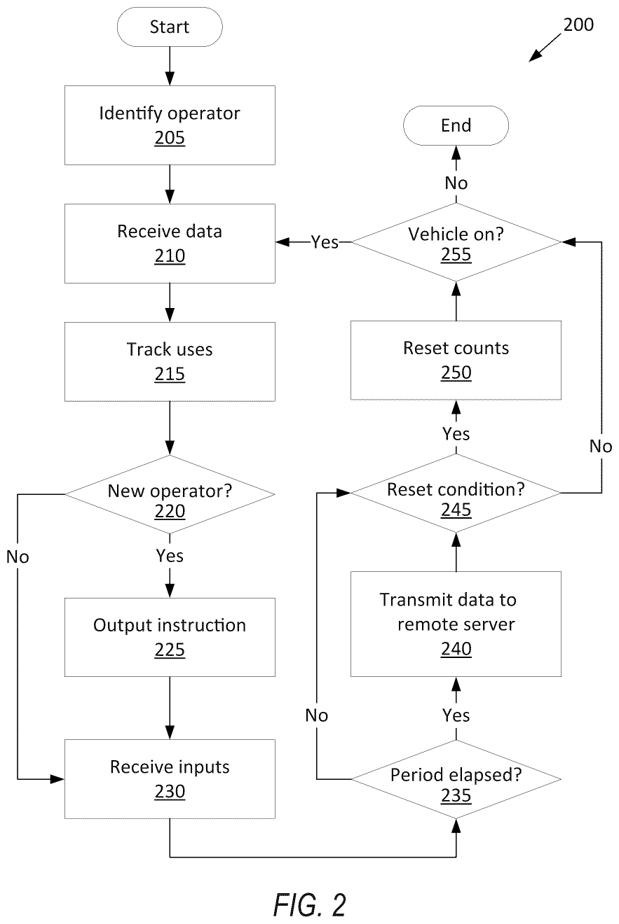

FIG. 2 is a flowchart illustrating an example process 200 for instructing an operator of the vehicle 100 based on classifying the operator as a new operator of the vehicle 100. The memory of the computer 105 stores executable instructions for performing the steps of the process 200 and/or programming can be implemented in structures such as mentioned above. As a general overview of the process 200, the computer 105 identifies the operator, receives data, and tracks the uses of the nondriving features. Upon classifying the operator as a new operator of the vehicle 100, the computer 105 outputs the instruction about the feature. The computer 105 receives data on the usage of the feature and, upon expiration of the period, transmits the data to the remote server 130. In response to the condition being satisfied, the computer 105 resets the tracked uses of the nondriving features and/or reclassifies the operator as an experienced operator. The process 200 continues for as long as the vehicle 100 remains on. The data stored to the memory of the computer 105 may persists to the next key cycle (i.e., to the next time performing the process 200).

The process 200 begins in a block 205, in which the computer 105 identifies the operator, as described above.

Next, in a block 210, the computer 105 receives data about usage of the nondriving features on the first and/or second lists.

Next, in a block 215, the computer 105 detects or tracks the uses of the nondriving features on the first and/or second lists, as described above.

Next, in a decision block 220, the computer 105 determines whether to classify the operator as a new operator of the vehicle 100, as described above. The computer 105 may classify the operator as a new operator of the vehicle 100 in response to the use of one of the nondriving features on the first list. Alternatively or additionally, the computer 105 may calculate the summation of the nondriving features on the second list and classify the operator as a new operator of the vehicle 100 in response to the summation exceeding the threshold, as described above. In response to the operator being a new operator of the vehicle 100, the process 200 proceeds to a block 225. In response to the operator being an experienced operator or having an unknown experience level, the computer 105 refrains from actuating the user interface 110 to convey the instruction about the feature, and the process 200 proceeds to a block 230.

In the block 225, the computer 105 actuates the user interface 110 to convey the instruction to the operator about using the feature, as described above. After the block 225, the process 200 proceeds to the block 230.

In the block 230, the computer 105 receives data about the usage of the feature, as described above.

Next, in a decision block 235, the computer 105 determines whether the preset period for transmitting the data about the usage of the feature has expired, as described above. In response to the period expiring, the process 200 proceeds to a block 240. In response to the period being in progress, the process 200 proceeds to a decision block 245.

In the block 240, the computer 105 transmits the data about the usage of the feature to the remote server 130, as described above. After the block 240, the process 200 proceeds to the decision block 245.

In the decision block 245, the computer 105 determines whether the condition for resetting is satisfied, as described above. In response to the condition being satisfied, the process 200 proceeds to a block 250. In response to the condition not being satisfied, the process 200 proceeds to a decision block 255.

In the block 250, the computer 105 resets the classification of the operator and/or the tracked uses of the nondriving features, as described above. After the block 250, the process 200 proceeds to the decision block 255.

In the decision block 255, the computer 105 determines whether the vehicle 100 is on (i.e., is in an on state). For the purposes of this disclosure, “on state” is defined as the state of the vehicle 100 in which full electrical energy is provided to electrical components of the vehicle 100 and the vehicle 100 is ready to be driven (e.g., the engine is running); “off state” is defined as the state of the vehicle 100 in which a low amount of electrical energy is provided to selected electrical components of the vehicle 100, typically used when the vehicle 100 is being stored; and “accessory-power state” is defined as the state of the vehicle 100 in which full electrical energy is provided to more electrical components than in the off state and the vehicle 100 is not ready to be driven. Typically, the operator puts the vehicle 100 into the on state when the operator is going to operate the vehicle 100, puts the vehicle 100 into the off state when the operator is going to leave the vehicle 100, and puts the vehicle 100 into the accessory-power state when the operator is going to sit in but not operate the vehicle 100. In response to the vehicle 100 being in the on state, the process 200 returns to the block 210 to continue receiving data about the nondriving features. In response to the vehicle 100 being in the off state or the accessory-power state, the process 200 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. Use of “in response to,” “upon determining,” “upon classifying,” etc. indicates a causal relationship, not merely a temporal relationship. The adjectives “first” and “second” are used throughout this document as identifiers and are not intended to signify importance, order, or quantity. Many modifications and variations of the present disclosure are possible in light of the above teachings, and the disclosure may be practiced otherwise than as specifically described.

What is claimed is:

1. A computer comprising a processor and a memory, the memory storing instructions executable by the processor to:
classify an operator of a vehicle as a new operator of the vehicle based on use of at least one nondriving feature of the vehicle by the operator; and
in response to the operator being a new operator of the vehicle, actuate a user interface of the vehicle to convey an instruction to the operator about using a different feature of the vehicle than the at least one nondriving feature.

2. The computer of claim 1, wherein the at least one nondriving feature includes at least one of storing a new seat position of a seat of the vehicle, changing a language used by the user interface, disabling a rear seat occupancy alert, storing a new device as a digital key, or storing a new entry code for unlocking the vehicle.

3. The computer of claim 1, wherein the instructions further include instructions to classify the operator as a new operator of the vehicle based on a summation of the uses of the at least one nondriving feature.

4. The computer of claim 3, wherein:
the at least one nondriving feature includes a plurality of nondriving features; and
the summation is a weighted sum of the respective uses of the respective nondriving features.

5. The computer of claim 3, wherein the instructions further include instructions to classify the operator as a new operator of the vehicle in response to the summation exceeding a threshold.

6. The computer of claim 3, wherein:
the instructions further include instructions to identify the operator; and
the summation is limited to the uses of the at least one nondriving feature by the identified operator.

7. The computer of claim 1, wherein the instructions further include instructions to transmit data indicating usage of the different feature by the operator to a server remote from the vehicle, the usage of the different feature being after the operator received the instruction.

8. The computer of claim 7, wherein the instructions further include instructions to transmit the data to the server on a periodic basis.

9. The computer of claim 1, wherein the instructions further include instructions to:
in response to a condition being satisfied, reclassify the operator from a new operator of the vehicle to an experienced operator of the vehicle; and
in response to the operator being an experienced operator, refrain from actuating the user interface to convey the instruction about using the different feature of the vehicle.

10. The computer of claim 1, wherein the at least one nondriving feature includes storing a new seat position of a seat of the vehicle.

11. The computer of claim 1, wherein the at least one nondriving feature includes changing a language used by the user interface.

12. The computer of claim 1, wherein the at least one nondriving feature includes disabling a rear seat occupancy alert.

13. The computer of claim 1, wherein the at least one nondriving feature includes storing a new device as a digital key.

14. The computer of claim 1, wherein the at least one nondriving feature includes storing a new entry code for unlocking the vehicle.

15. A method comprising:
classifying an operator of a vehicle as a new operator of the vehicle based on use of at least one nondriving feature of the vehicle by the operator; and
in response to the operator being a new operator of the vehicle, actuating a user interface of the vehicle to convey an instruction to the operator about using a different feature of the vehicle than the at least one nondriving feature.

16. The method of claim 15, wherein the at least one nondriving feature includes at least one of storing a new seat position of a seat of the vehicle, changing a language used by the user interface, disabling a rear seat occupancy alert, storing a new device as a digital key, or storing a new entry code for unlocking the vehicle.

17. The method of claim 15, further comprising classifying the operator as a new operator of the vehicle based on a summation of the uses of the at least one nondriving feature.

18. The method of claim 17, wherein:
the at least one nondriving feature includes a plurality of nondriving features; and
the summation is a weighted sum of the respective uses of the respective nondriving features.

19. The method of claim 17, further comprising classifying the operator as a new operator of the vehicle in response to the summation exceeding a threshold.

20. The method of claim 17, further comprising identifying the operator, wherein the summation is limited to the uses of the at least one nondriving feature by the identified operator.
